(19) United States
(12) Patent Application Publication
(10) Pub. No.: US 2026/0365813 A1
(43) Pub. Date: Nov. 19, 2026

(54) METHOD OF MODIFYING WASTE POLYSTYRENE (PS) TO PROVIDE A BIODEGRADABLE PRODUCT

(71) Applicant: KING SAUD UNIVERSITY, RIYADH (SA)

(72) Inventors: NAZRUL HAQ RIZWANUL HAQ, RIYADH (SA); MOUNIR SALEM BEKHIT, RIYADH (SA); RAISUDDIN ALI MOHAMMAD, RIYADH (SA); MUDASSAR AHMAD SHAHID, RIYADH (SA); SYED RIZWAN AHAMAD, RIYADH (SA); FARS KAED ALANAZI, RIYADH (SA)

(21) Appl. No.: 19/207,670

(22) Filed: May 14, 2025

(51) Int. Cl. C08J 11/08; B09B 3/60; B09B 101/75; C08J 3/215; C08J 5/18; C08K 5/09; C08K 5/1545; C08L 25/06

(52) U.S. Cl. CPC C08J 11/08; B09B 3/60; C08J 3/215; C08J 5/18; C08K 5/09; C08K 5/1545; C08L 25/06; B09B 2101/75; C08J 2325/06; C08L 2201/06; C08L 2207/20; C08L 2207/322

(57) ABSTRACT

A method of modifying waste polystyrene (PS) for biodegradation includes dissolving a waste PS in a volatile, non-polar solvent (in which PS is freely soluble) to provide a first solution; adding a biodegradable material to the first solution to provide a second solution; mixing the waste PS and the biodegradable material in the second solution to provide a transparent third solution; transferring the transparent solution into a different container; and evaporating the non-polar solvent in the container to form a composite film in the container.

### BACKGROUND

### 1. Field

The present disclosure relates to a method of degrading waste polystyrene (PS) and, particularly, to a method of modifying waste polystyrene (PS) to provide a biodegradable product.

### 2. Description of fhe Related Art

Like other plastics, polystyrene (PS) is widely used because of its good mechanical properties and relatively low cost. For example, PS is widely used in construction materials (insulation), packaging foam, food containers, disposable cups, plates, cutleries, cassette boxes, and compact disks. PS comprises about 7% of the total amount of plastics produced

As a result of such wide use, plastics including PS have accumulated in the environment, causing environmental pollution, human health problems, and ecosystem changes due to their toxicity and recalcitrant compounds.

The hydrophobic character of most thermoplastics including PS makes them resistant to hydrolysis and prevents their biodegradation. Actually, biodegradation of PS does occur but at a very slow rate in natural environments and therefore PS persists for long periods of time as solid waste.

Thermoplastics have high molecular weights and their general lack of water solubility prevents microorganisms from transporting them into their cells for metabolism. Biological processes can start outside the microbial cell by the secretion of extracellular enzymes. However, these enzymes are too large to penetrate deep into the polymer, so they act on the surface by cleaving the polymer chain via hydrolytic mechanisms. Biological processes are further enhanced by the formation of functional groups in the polymer chain.

Biodegradability of pure/neat/virgin PS materials has been investigated in many previous studies. To increase biodegradability of PS in the environment, modifying PS by grafting/blending with copolymers or using the addition of prooxidants such as metal salt (iron, cobalt, and manganese) have been investigated. Satisfactory results in this regard have not previously been achieved.

Thus, a method of degrading waste polystyrene solving the aforementioned problems is desired.

### SUMMARY

The present subject matter relates to a method of modifying waste polystyrene (PS) to provide a biodegradable product. The method includes modification of waste non-biodegradable petroleum-based polymer with a biodegradable substance to enhance the biodegradation rate of the polymer in natural environmental conditions. The method demonstrated a faster rate of polystyrene degradation as compared to conventional methods.

A method of modifying waste polystyrene (PS) for biodegradation includes dissolving a waste PS in a volatile, non-polar solvent (in which PS is freely soluble) to provide a first solution; adding a biodegradable material to the first solution to provide a second solution; mixing the waste PS and the biodegradable material in the second solution to provide a transparent third solution; transferring the transparent solution into a different container; and evaporating the non-polar solvent in the container to form a composite film in the container.

A method of biodegrading waste polystyrene (PS) can include dissolving the waste PS in a volatile non-polar solvent to provide a first solution; adding a biodegradable material to the first solution to provide a second solution; mixing the waste PS and the biodegradable material in the second solution to provide a transparent solution; transferring the transparent solution into a container, evaporating the non-polar solvent in the container to form a composite film in the container, and adding a culture nutrient medium including a microbe to the composite film for biodegrading the composite film.

These and other features of the present subject matter will become readily apparent upon further review of the following specification.

### BRIEF DESCRIPTION OF THE DRAWINGS

FIG. 1 is a graph showing TGA of waste polystyrene (PS) alone and of the modified waste polystyrene (PS) or polystyrene-oleic acid PS-OA composite film, according to the present teachings.

FIG. 2 shows the FTIR of polystyrene (PS) alone

FIG. 3 shows the FTIR of the untreated PS-OA composite film.

FIG. 4 shows the FTIR of treated PS alone overlayed on the FTIR of untreated PS-OA blend film.

FIG. 5 shows the GPC of treated PS alone overlaid on and the GPC of untreated PS-OA composite film

FIG. 6 shows an SEM image of untreated PS-OA composite film (3kX).

FIGS. 7A-7D show SEM images of treated PS-OA composite film at different magnifications.

FIG. 8 is a graph showing untargeted GC-MS analysis of the medium indicating the presence of toluene, xylene and 1,2,3-trimethyl-benzene.

FIG. 9A is an image identifying Bacillus on film incubated with microbes present in soil.

FIG. 9B is an image identifying Bacillus on film incubated with microbes present in wastewater.

FIG. 10A is an SEM image of a PS-OA composite film buried in soil, showing clear signs of biodegradation in the form of holes and cracks,

FIG. 10B is an SEM image of PS-OA composite film buried in wastewater for 2 months, showing clear signs of biodegradation in the form of holes and cracks.

### DETAILED DESCRIPTION OF THE PREFERRED EMBODIMENTS

The following definitions are provided for the purpose of understanding the present subject matter and for construing the appended patent claims.

### Definitions

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

It will be understood by those skilled in the art with respect to any chemical group containing one or more substituents that such groups are not intended to introduce any substitution or substitution patterns that are sterically impractical and/or physically non-feasible.

Unless defined otherwise, all technical and scientific terms used herein have the same meaning as commonly understood to one of ordinary skill in the art to which the presently described subject matter pertains.

Where a range of values is provided, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

Throughout the application, descriptions of various embodiments use “comprising” language. However, it will be understood by one of skill in the art, that in some specific instances, an embodiment can alternatively be described using the language “consisting essentially of” or “consisting of”.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about”. Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

An embodiment of the present subject matter relates to a method of modifying waste polystyrene (PS) for biodegradation, including dissolving the waste PS in a volatile non-polar solvent to provide a first solution; adding a biodegradable material to the first solution to provide a second solution; mixing the waste PS and the biodegradable material in the second solution to provide a transparent solution; transferring the transparent solution into an container; and evaporating the non-polar solvent in the container to form a composite film in the container. In an embodiment, a culture nutrient medium including a microbe can be added to the composite film for biodegrading the composite film.

In an embodiment, the non-polar solvent is selected from the group consisting of ethyl acetate and tetrahydrofuran. In an embodiment, the biodegradable material is selected from the group consisting of a surfactant, a surfactant component, a biosurfactant, a biosurfactant component, a vegetable oil, and a vegetable oil component. In an embodiment, the vegetable oil component comprises oleic acid. In an embodiment, the surfactant is Tween-80. In an embodiment, the biosurfactants are selected from the group consisting of glycolipids and rhamnolipids. In an embodiment, the vegetable oil is selected from the group consisting of mustard oil, coconut oil, and olive oil.

According to an embodiment, the non-polar solvent comprises ethyl acetate. In an embodiment, the container comprises a petri dish. In an embodiment, mixing the waste PS and the biodegradable material in the second solution comprises vortexing the waste PS and the biodegradable material in the second solution. In an embodiment, the composite film is white.

A method of biodegrading waste polystyrene (PS) can include dissolving the waste PS in a volatile non-polar solvent to provide a first solution; adding a biodegradable material to the first solution to provide a second solution; mixing the waste PS and the biodegradable material in the second solution to provide a transparent solution; transferring the transparent solution into a container, evaporating the non-polar solvent in the container to form a composite film in the container, and adding a culture nutrient medium including a microbe to the composite film for biodegrading the composite film.

In an embodiment, the culture nutrient medium is devoid of any carbon source and includes NH₄NO₃, K₂HPO₄, MgSO₄, KCl, CaCl₂, a microbe, and water. In an embodiment the culture nutrient medium comprises NH₄NO₃, K₂HPO₄, MgSO₄, KCl, CaCl₂, water, FeSO₄, ZnSO₄, a microbe, water, and MnSO₄ In an embodiment, the microbe in the culture nutrient medium includes Bacillus sp. In an embodiment, after adding the culture nutrient medium to the composite film, the container can be gently shaken, e.g., in a shaker, and maintained at a temperature ranging from about 33 °C to about 40 °C, e.g., about 37 °C, and a speed of about 115 rpm to about 125 rpm, e.g., about 120 rpm. In an embodiment, the composite film can be exposed to the culture nutrient medium for at least about 3 months.

The present teachings are illustrated by the following Examples.

### EXAMPLES

### Example 1

### Synthesis of Waste Polystyrene (PS) Composite Film

Waste PS was modified prior to bio-degradation by dissolving 05 g of the waste PS in 100 mL of ethyl acetate (volatile non-polar solvent) to provide a clear waste PS solution; 2) adding 02 mL of oleic acid (another biodegradable material) dropwise in the clear waste PS solution; 3) mixing well both the waste PS solution and the oleic acid by vortexing; and 4) pouring the clear transparent solution mixture of PS+biomaterial in a petri dish and letting the solvent to evaporate to allow the formation of the composite film.

### Example 2

### Biodegradation

The white composite film obtained as described above was subjected to biodegradation by exposing it to a synthetic culture nutrient medium devoid of any carbon source (other than the composite film) and including Bacillus sp. The synthetic culture nutrient medium included the following elements (grams in 1 liter of distilled water): NH₄NO₃ 1.0; K₂HPO₄ 1.0; MgSO₄.7H₂O 0.2; KCl 0.15; CaCl₂.2H₂O 0.1; and each of the following microelements: 1.0 mg l-1 FeSO₄.6H₂O, 1.0 mg l-1 ZnSO₄.7H₂O, and 1.0 mg l-1 MnSO₄.

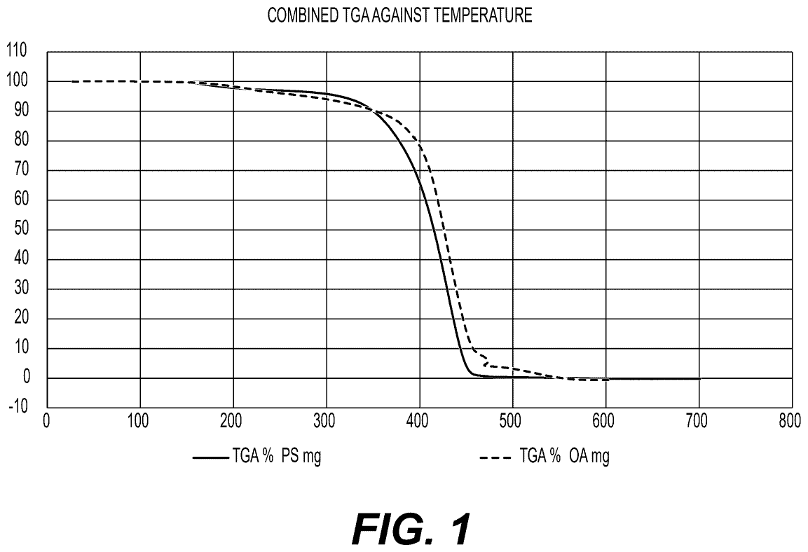

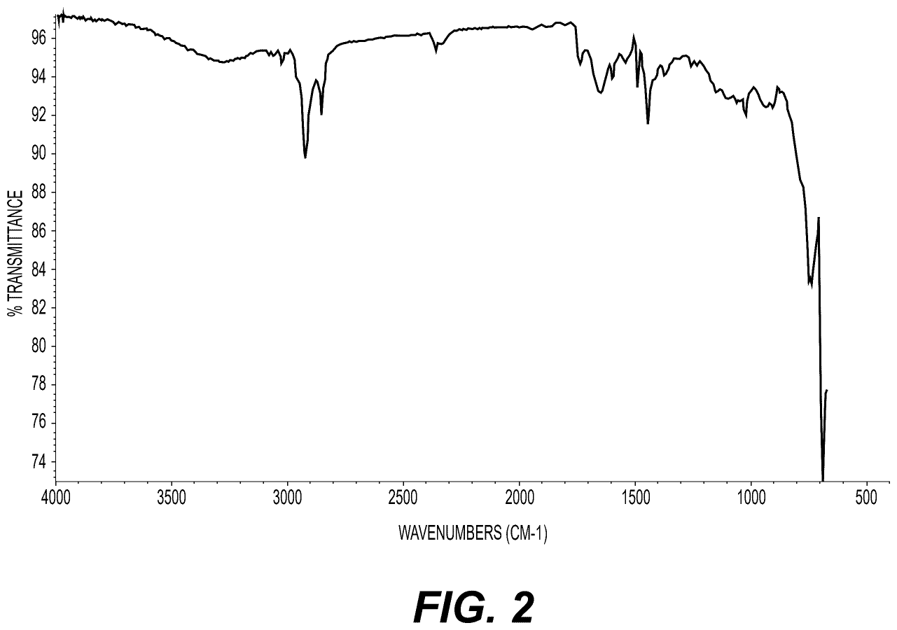

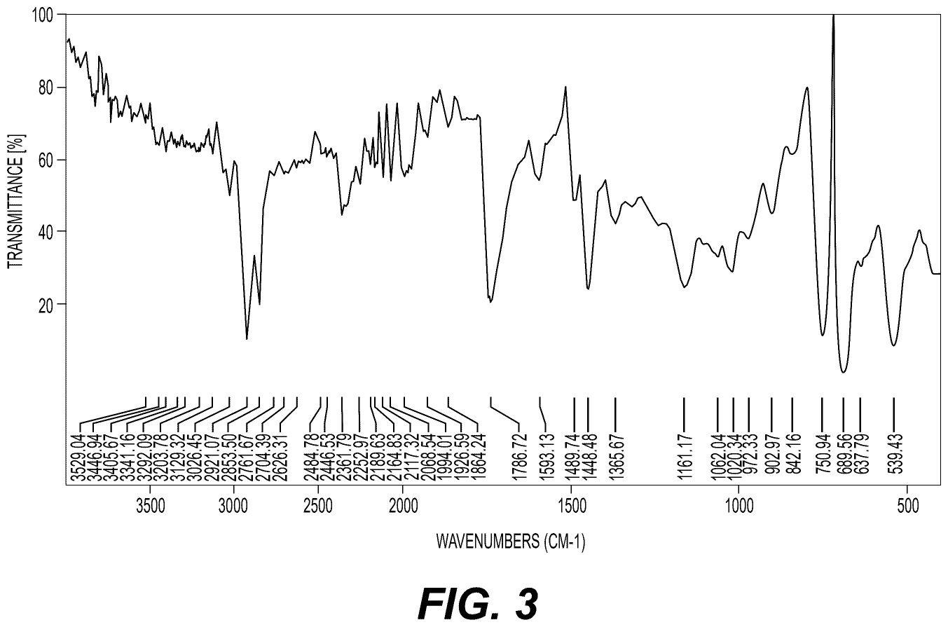

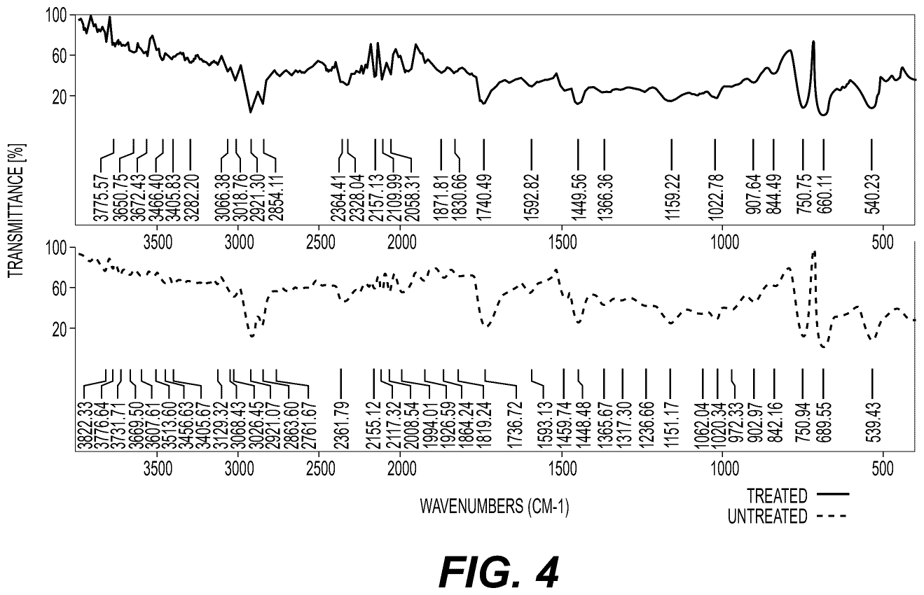

The experimental set up was kept in a shaker and maintained at 37 °C and 120 rpm speed. The experiment continued for 3 months. After 3 months, the flakes of composite film were carefully removed from the flask, washed with ethanol several times to remove any biomass, and then examined for possible biodegradation by Fourier Transform Infra-Red spectroscopy (FTIR) (FIGS. 1A-1B), gel-permeation chromatography (GPC) (FIG. 2), GC-MS and Scanning Electron Microscopy (SEM) (FIG. 3).

### Example 2

### Fourier Transform Infra-Red spectroscopy (FTIR)

FTIR spectroscopy was used to verify that blending had occurred. Referring to FIG. 1, the characteristic peaks corresponding to 689, 750, 1489, 1593 and 3026 cm⁻¹ are related to the C—H bond stretching of the aromatic rings. The peak at 2068 cm⁻¹ is associated with the C ¼ C bond stretching in the aromatic rings, and those at 2853 cm⁻¹ and 2921 cm⁻¹ correspond to the C—H bond stretching of CH₂ groups. All of these peaks confirm the presence of aromatic moieties from the PS in the blend. The intense band observed at 1736 cm⁻¹ is attributed to asymmetric —C═O stretch and the band at 1161 cm⁻¹ corresponds to the C—O stretch, both indicating the presence of oleic acid in the blend. The intense band at 1736 cm⁻¹, characteristic of oleic acid, was almost absent in the spectrum of pure PS (FIG. 2). This indicates that the oleic acid is now somehow physically associated with PS in the blend.

On comparing the FTIR spectra of untreated and treated modified PS film (FIG. 3), there is a decrease in the intensities of the observed peaks in the treated blend film with respect to the untreated one which indicates that although the entire blend film has not biodegraded, the respective amounts of the constituents has decreased. The availability of oleic acid molecule as an available carbon source on the surface of the blend film helps in the biodegradation of PS along with oleic acid.

The dominant thermal degradation mechanism of PS is chain scission and free radical diffusion. PS degradation was initiated by scissoring of the C-C bond by the thermal energy and was accompanied by transferred hydrogen to the site of scission. The behavior of blend at the onset of thermal degradation can be viewed in terms of the ability of oleic acid to diffuse in the polymer matrix. It was previously reported that the suppression of chain mobility by additives is the main reason for the ameliorating effect. Chain scission is a result of free radical diffusion among polymer chains; the chains with decreased mobility provide a physical barrier for free radical diffusion, hence the polymer degradation is delayed. The likely explanation behind the better thermal stability of the oleic acid reinforced nanocomposites is (i) the uniform dispersion and the good interfacial adhesion between the oleic acid and PS matrix; and (ii) the effective function of oleic acid as protective physical barriers to hinder the transport of volatile decomposed products out of PS blend during the thermal decomposition. This, in turn, may restrict the thermal motion of PS macromolecules, resulting in the enhancement of the thermal stability of PS (FIG. 1).

### Example 3

### Biodegradation

The residual polymer was further analyzed with gel-permeation chromatography (GPC) (FIG. 2) in order to detect any shift of the molecular weight distribution. During degradation (e.g., due to heat, UV, mechanical stress, or biochemical reactions), polymer chains break, reducing their molecular weight. Mn decreases more significantly than Mw, as chain scission primarily affects the number of small fragments. Also, some degradation mechanisms (e.g., oxidative or thermal degradation) may lead to crosslinking. In that case, Mw increases as larger macromolecules form, while Mn might remain relatively unchanged or decrease slightly. If Mw decreases significantly, it indicates loss of the higher-molecular-weight species. If Mn decreases drastically relative to Mw, it suggests extensive chain scission. In addition to this, change in PDI is also a critical indicator of the changes happening in the molecular chains. With chain scission, the PDI typically increases because of the creation of more low-molecular-weight fragments or as the distribution widens due to high-molecular-weight species. A significant increase in PDI points to uneven degradation, with both fragmentation and potential crosslinking occurring.

Understanding these changes helps assess the stability and performance of polymers under various conditions. The weight-average molecular weight (Mw) of the PS pieces decreased continuously after being exposed to microbe (almost 13% decline was observed in Mw). Whereas in case of number-average molecular weight (Mn), a decrease of about 23% was observed after 3 months of exposure. The polydispersivity (Mw/Mn) of the treated modified PS film exhibited higher values than the untreated film (19% shift from the original value). When the GPC profiles of treated and untreated film were compared, no significant differences were observed in the main peak, however a tail in the longer retention times was observed suggesting the formation of lower molecular weight species which also led to the broadening of the molecular weight distribution as shown in FIG. 2.

### Example 4

### Scanning Electron Microscopy

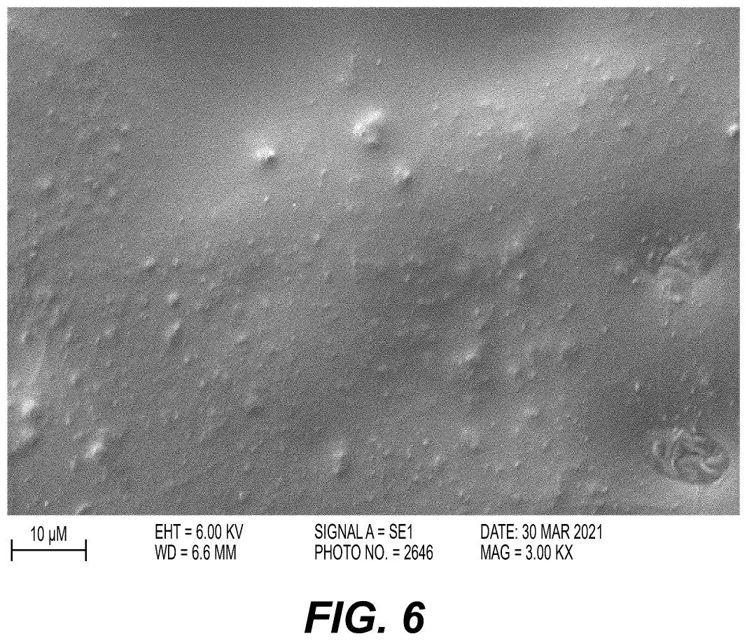

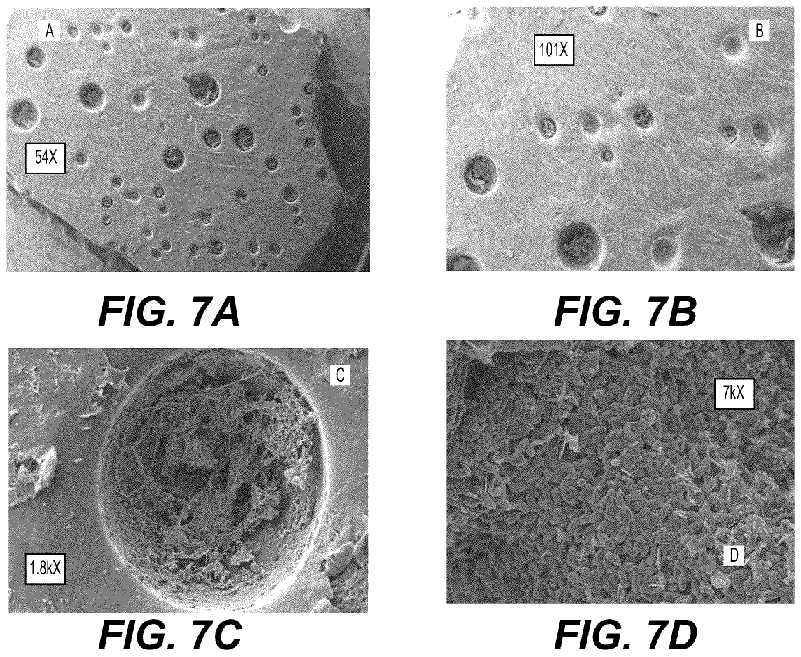

The comparison of SEM images of untreated and treated PS films revealed differences on the polymers' surface. The untreated samples had smoother surfaces without any significant cracks or holes. When incubated with the bacteria, many fissures/holes were detected throughout the surface and the roughness increased as shown in FIG. 6 and FIG. 7A-7D, indicating a good amount of biodegradation.

### Example 5

### TGA of Pure PS and PS-OA Composite

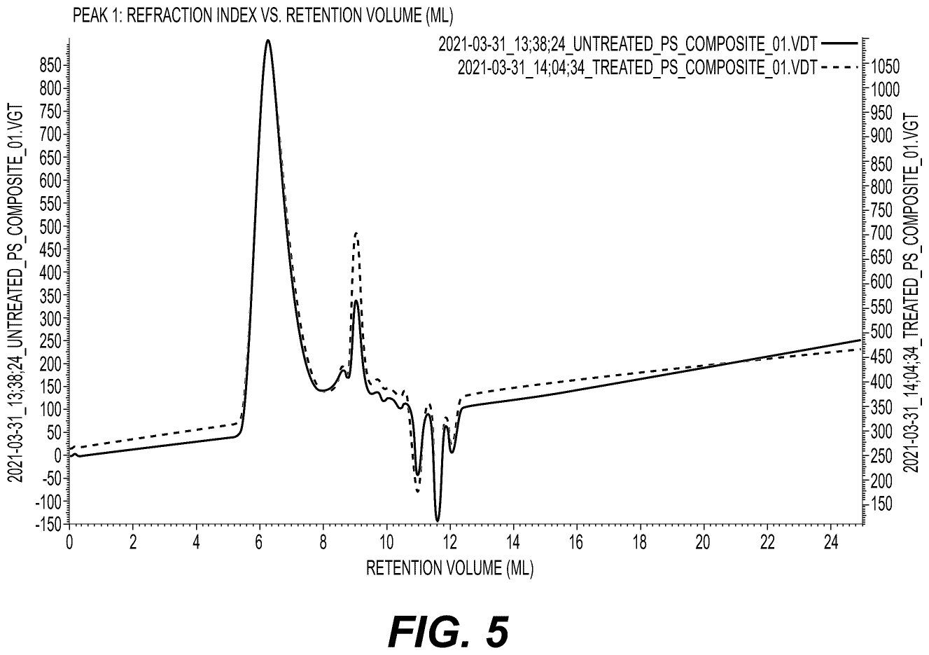

The dominant thermal degradation mechanism of PS is chain scission and free radical diffusion. PS degradation was initiated by scissoring of the C—C bond by the thermal energy and was accompanied by transferred hydrogen to the site of scission. The behavior of blend at the onset of thermal degradation can be viewed in terms of the ability of oleic acid to diffuse in the polymer matrix. It has previously been reported that the suppression of chain mobility by additives is the main reason for the ameliorating effect. Chain scission is a result of free radical diffusion among polymer chains; the chains with decreased mobility provide a physical barrier for free radical diffusion, hence the polymer degradation is delayed. The likely explanation behind the better thermal stability of the oleic acid reinforced nanocomposites is (i) the uniform dispersion and the good interfacial adhesion between the oleic acid and PS matrix; and (ii) the effective function of oleic acid as protective physical barriers to hinder the transport of volatile decomposed products out of PS blend during the thermal decomposition. This, in turn, may restrict the thermal motion of PS macromolecules, resulting in the enhancement of the thermal stability of PS (FIG. 5).

### Example 6

### Analysis of End Product

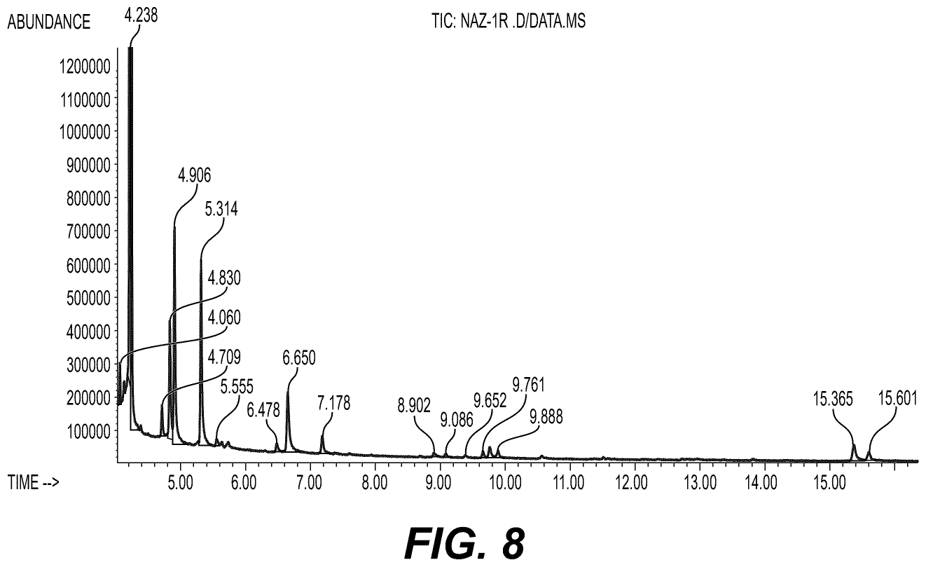

Mineral medium with inoculated organism and surface sterilized modified polystyrene films were incubated for 3 months at 37 °C and after that cells were removed and the collected supernatant was filtered through a 0.2 μm filter paper and the clear filtrate was subject to liquid-liquid extraction with ethyl acetate. After extraction, the organic part was subject to untargeted GC-MS analysis. Polystyrene on microbial degradation lead to the formation of many intermediates, including, toluene (Rt=4.83, abundance=94%), xylene (Rt=6.65, abundance=97%) and 1,2,3-trimethyl-benzene (Rt=9.76, abundance=94%). Since the additive oleic acid, used to modify polystyrene, is a straight chain molecule, presence of these aromatic benzene ring-containing molecules indicates that the chain of polystyrene is breaking (FIG. 8).

### Example 7

### Real Time Degradation Studies

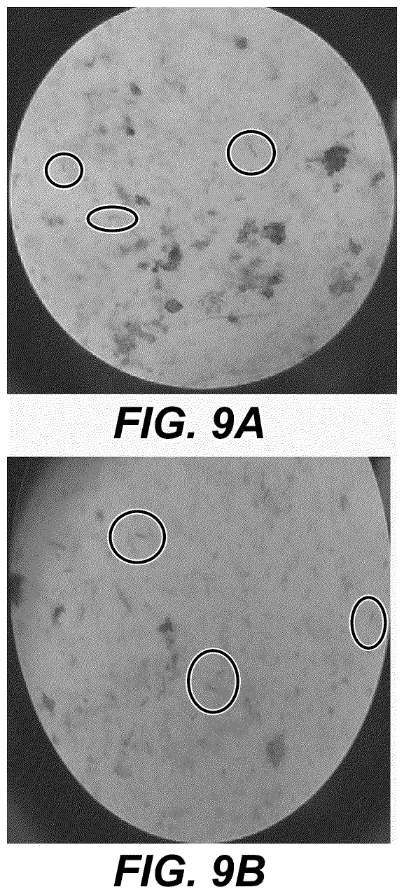

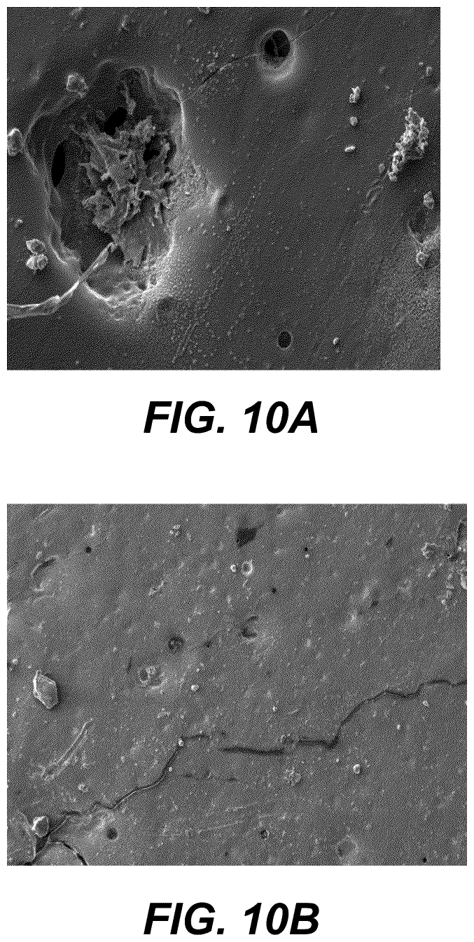

A loop full soil and 1 ml of domestic wastewater was separately used to inoculate second media with film and grown with minimal media for 60 days at 30 °C and 100 RPM in a shaking incubator. Post incubation culture was taken from the film and stained with Gram staining to identify the class of bacteria. A smear was prepared with the culture on the film, air dried, and heat fixed, followed by flooding the smear with crystal Violet for 1 minute, and rinsing with water. Gram's Iodine was added for a minute and rinsed with water. The smear was decolorized with 95% alcohol for about 20 seconds and rinsed with water. The smear was counter-stained with safranin for about a minute and washed with water. The air-dried slide was observed under the microscope. The light microscopic and SEM viewing of the slides indicated the presence of Bacillus sp. which in turn suggested the biofilm formation at the surface of the film (FIGS. 9A-9B). Biofilm formation at the surface of the polystyrene is considered as the first step of biodegradation. Surface characterization of the plastic film (separately buried in the soil and by keeping in a drain pipe in continuous contact with flowing waste water from house) by SEM revealed the presence of holes and cracks suggesting the change in film. (FIGS. 10A-10B). SEM of PS-OA composite film kept in contact of domestic wastewater for 2 months showing clearly the sign of biodeterioration in the form of holes and cracks.

It is to be understood that the method of modifying waste polystyrene (PS) for biodegradation is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A method of modifying waste polystyrene (PS) for biodegradation, comprising:
dissolving a waste polystyrene (PS) in a polar solvent to provide a first solution;
adding a biodegradable material to the first solution to provide a second solution, the biodegradable material selected from the group consisting of a surfactant, a surfactant component, a biosurfactant, a biosurfactant component, a vegetable oil, and a vegetable oil component, the vegetable oil component comprising oleic acid;
mixing the waste polystyrene (PS) and the biodegradable material in the second solution;
transferring the second solution into a container; and
evaporating the non-polar solvent in the container to form a composite film in the container.

2. The method of claim 1, wherein the polar solvent is selected from the group consisting of ethyl acetate and tetrahydrofuran.

3. The method of claim 2, wherein the polar solvent is ethyl acetate.

4. (canceled)

5. (canceled)

6. (canceled)

7. The method of claim 1, wherein the surfactant is Tween-80.

8. The method of claim 1, wherein the biosurfactants are selected from the group consisting of glycolipids and rhamnolipids.

9. The method of claim 1, wherein the vegetable oil is selected from the group consisting of mustard oil, coconut oil, and olive oil.

10. A method of modifying waste polystyrene (PS) for biodegradation, comprising:
dissolving a waste polystyrene (PS) in a polar solvent to provide a first solution;
adding a biodegradable material to the first solution to provide a second solution;
mixing the waste polystyrene (PS) and the biodegradable material in the second solution;
transferring the second solution into a container;
evaporating the polar solvent in the container to form a composite film in the container;
adding a culture nutrient medium comprising NH₄NO₃, K₂HPO₄, MgSO₄, KCl, CaCl2, and water, wherein the polar solvent is selected from the group consisting of ethyl acetate and tetrahydrofuran.

11. The method of claim 10, wherein the polar solvent is tetrahydrofuran.

12. The method of claim 10, wherein the polar solvent is ethyl acetate.

13. The method of claim 10, wherein the biodegradable material is selected from the group consisting of a surfactant, a surfactant component, a biosurfactant, a biosurfactant component, a vegetable oil, and a vegetable oil component.

14. The method of claim 13, wherein the vegetable oil component comprises oleic acid.

15. The method of claim 13, wherein the polar solvent is ethyl acetate.

16. (canceled)

17. (canceled)

18. The method of claim 10, wherein the culture nutrient medium further comprises FeSO₄, ZnSO₄, and MnSO₄.
